(19) United States
(12) Patent Application Publication
(10) Pub. No.: US 2007/0109312 A1
(43) Pub. Date: May 17, 2007

(54) Image processing apparatus, pattern detecting method, program, and recording medium

(75) Inventors: Takashi Wada, Nara-shi (JP); Yoshiyuki Nakai, Nara-shi (JP); Koichi Sumida, Tenri-shi (JP); Yohichi Shimazawa, Nara-shi (JP); Akihiko Taniguchi, Yamato-Koriyama-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/589,019

(22) Filed: Oct. 27, 2006

(30) Foreign Application Priority Data
Nov. 11, 2005 (JP) 2005-327843

(51) Int. Cl. G09G 5/02

(52) U.S. Cl. 345/589

(57) ABSTRACT

An image processing apparatus is provided that can make judgment of a specific pattern accurate and easy and can judge a copying-prohibited original document regardless of the color of the original document and inputted image information of the copying-prohibited original document added with the specific pattern and even when the size of the specific pattern differs. A black detecting color filter executes a binarizing process to inputted image data in terms of black, and a yellow detecting color filter executes a binarizing process to inputted image data in terms of yellow. The black and yellow primitive pattern detecting portions respectively detect black primitive patterns and yellow primitive patterns from the black and yellow binarized image data. The copying-prohibiting added pattern detecting portion detects a specific pattern based on an arrangement of the primitive patterns detected by the black and yellow primitive pattern detecting portions.

### CROSS-NOTING PARAGRAPH

This Non-provisional application claims priority under 35 U.S.C. §119 (a) on Patent Application No. 2005-327843 filed in JAPAN on Nov. 11, 2005, the entire contents of which are hereby incorporated herein by reference.

### FIELD OF THE INVENTION

The present invention relates to an image processing apparatus, a pattern detecting method, a program, and a recording medium, and more specifically to an image processing apparatus having a function of detecting a specific pattern, a pattern detecting method of detecting a specific pattern, a program for pattern detection incorporated into the apparatus, and a computer-readable recording medium that is recorded with the program.

### BACKGROUND OF THE INVENTION

To prevent unauthorized copying of a printed original document, an approach of adding a specific pattern (specific image information) such as a background tint when an original document is printed has been used. The specific image information is also referred to as “copying-preventing information” or “anti-copying information”.

A method of adding specific image information can be a method of mixing confusingly information within a frequency region like an electronic watermark, a method of adding a bar code, etc., to a non-image area, or a method of adding information such as a watermark to an image area. Using such a method, for example, when image data is transmitted from an application running on a PC, etc., to a printer and, when the image data is outputted by printing by the printer, specific image information to prevent copying of a printed image is transmitted to the printer together with the above image data and, thereby, the printer outputs the image to be printed by printing with the specific image information embedded somewhere therein. A printed item is also outputted being embedded with specific image information by a dedicated printer.

The specific image information as above is embedded in a printed image in the form that can not be identified by users or is embedded in a printed image for discouraging the copying in the form that can be identified by users. Regardless of being identifiable or not identifiable by a user, when a user tries to copy a printed image embedded with the specific image information using a copying machine, the copying machine detects the specific image information and will not output the copy printing or executes an operation such as outputting by printing of words such as “Copy Prohibited”.

As above, conventionally, in a copying machine such as a color copying machine, a method of adding a specific pattern that is difficult to be discriminated visually to each copied item is employed to identify a copying-prohibited original document, and the copying-prohibited original document is identified by detecting the specific pattern. However, such a specific pattern has a pattern shape and a pattern color thereof to make themselves difficult to be discriminated visually and, as a result, it is difficult for the copying machine to discriminate a specific pattern depending on the color of the original document to be added with the specific pattern or inputted image information. As a result, a problem has arisen that the copying machine does not regard the copying-prohibited original document carrying the specific pattern as a copying-prohibited original document.

One measure against the above problem can be a technique disclosed in Japanese Laid-Open Patent Publication No. H9-16043, according to which color extraction of one color of an inputted image received by a copying machine is executed for color extraction of a plurality of colors, the results of the extraction respectively for the plurality of colors are integrated into one, and whether a predetermined specific pattern is included in the inputted image is judged based on the result of the integration.

However, according to the technique in Japanese Laid-Open Patent Publication No. H9-16043, the judgment of the specific pattern may be difficult due to information other than the specific pattern because the color extraction is executed to the specific pattern together with the color of the original document to which the specific information is added and the inputted image information and the judgment of the specific pattern is executed after the extraction results of the plurality of colors are integrated. When the specific pattern differs in size depending on the color thereof, the judgment maybe difficult when the judgment is executed after the results of the extraction are integrated into one.

### SUMMARY OF THE INVENTION

The object of the present invention is to provide an image processing apparatus, a pattern detecting method, a program for pattern detection incorporated into the apparatus, and a computer-readable recording medium that is recorded with the program, that can make judgment of a specific pattern accurate and easy and can judge a copying-prohibited original document regardless of the color of the original document and inputted image information of the copying-prohibited original document added with the specific pattern and even when the size of the specific pattern differs.

More specifically, an object of the present invention is to provide an image processing apparatus comprising: a binarizing portion that separates a plurality of single colors from image data inputted and binarizes the single colors; a primitive pattern detecting portion that detects a primitive pattern for each color from the image data of the single colors that is binarized by the binarizing portion; and a specific pattern detecting portion that detects a specific pattern based on an arrangement of the primitive pattern detected by the primitive pattern detecting portion.

Another object of the present invention is to provide the image processing apparatus, comprising: an integrating portion that integrates into one the primitive patterns detected by the primitive pattern detecting portion respectively for the single colors, wherein the specific pattern detecting portion detects the specific pattern based on an arrangement of the primitive pattern integrated by the integrating portion.

Another object of the present invention is to provide the image processing apparatus, wherein the integrating portion is an adding portion that integrates into one the primitive patterns detected by the primitive pattern detecting portion respectively for the single colors by adding these patterns to each other.

Another object of the present invention is to provide the image processing apparatus, wherein the integrating portion is a selecting portion that selects data from which the primitive pattern is detected of the primitive patterns detected by the primitive pattern detecting portion respectively for the single colors.

Another object of the present invention is to provide the image processing apparatus, comprising: a representative point detecting portion that obtains a representative point in the primitive pattern from the primitive patterns detected by the primitive pattern detecting portion respectively for the single colors.

Another object of the present invention is to provide the image processing apparatus, wherein the representative point detecting portion has a line-thinning portion that obtains the representative point in the primitive pattern by line-thinning.

Another object of the present invention is to provide the image processing apparatus, wherein the primitive pattern detecting portion executes a predetermined process when the number of primitive patterns detected for each color is smaller than a threshold value determined from the number of the specific patterns to be extracted by the specific pattern detecting portion.

Another object of the present invention is to provide the image processing apparatus, wherein the primitive pattern detecting portion has a consecutive pixel counter that counts the number of consecutive pixels, and determines unnecessary data based on a count value of the consecutive pixel counter.

Another object of the present invention is to provide the image processing apparatus, wherein the specific pattern is a pattern that indicates prohibition of copying, and wherein the image processing apparatus comprises an outputting prohibiting portion that prohibits outputting of an inputted image when more specific patterns than a predetermined number thereof are detected by the specific pattern detecting portion.

Another object of the present invention is to provide a pattern detecting method comprising: a binarizing step of separating a plurality of single colors from image data inputted and binarizing the single colors; a primitive pattern detecting step of detecting a primitive pattern for each color from the image data of the single colors that is binarized at the binarizing step; and a specific pattern detecting step of detecting a specific pattern based on an arrangement of the primitive pattern detected at the primitive pattern detecting step.

Another object of the present invention is to provide the pattern detecting method, further comprising: an integrating step of integrating into one the primitive patterns detected at the primitive pattern detecting step respectively for the single colors, wherein at the specific pattern detecting step, the specific pattern is detected based on an arrangement of the primitive pattern integrated at the integrating step.

Another object of the present invention is to provide a program that is incorporated into the image processing apparatus and causes a processing unit in the image processing apparatus to function as each portion.

Another object of the present invention is to provide a computer-readable recording medium that is recorded with the program.

### BRIEF DESCRIPTION OF THE DRAWINGS

FIG. 1 is a block diagram of an exemplary system configuration of an image processing apparatus of the present invention;

FIG. 2 is a block diagram of an exemplary configuration of an image processing apparatus according to an embodiment of the present invention;

FIG. 3 shows an exemplary arrangement of a plurality of copying-prohibiting added patterns arranged in an original document;

FIG. 4 is an explanatory view of processes to an exemplary original document with a yellow copying-prohibiting added pattern arranged in a black image;

FIG. 5 is an explanatory view of processes to an exemplary original document with a black copying-prohibiting added pattern arranged in a yellow image;

FIG. 6 is an explanatory view of processes to an exemplary original document with a yellow copying-prohibiting added pattern arranged in a black-and-yellow image;

FIG. 7 is an explanatory view of processes continued from FIG. 6; and

FIG. 8 is an explanatory block diagram of an exemplary configuration of a digital multi-function peripheral that is an example of the image processing apparatus of the present invention.

### PREFERRED EMBODIMENTS OF THE INVENTION

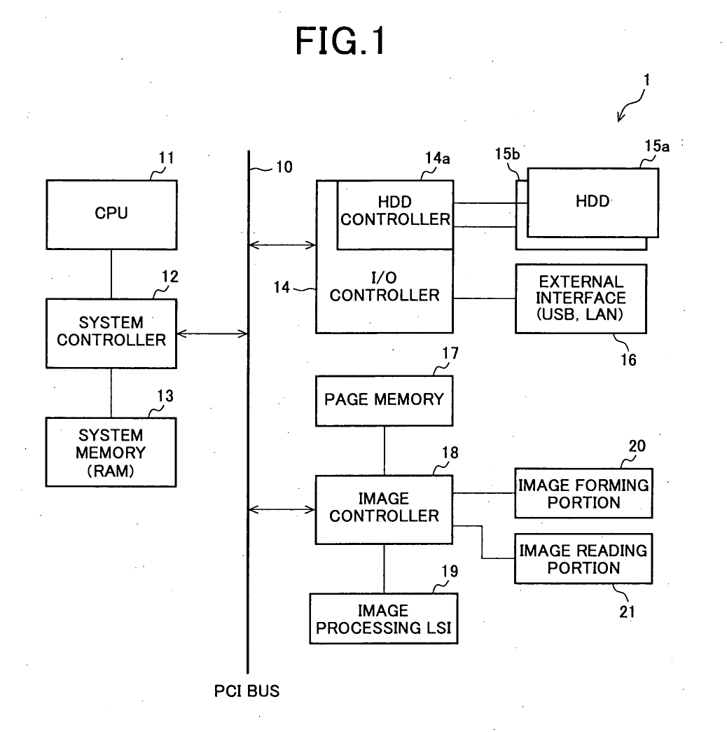

FIG. 1 is a block diagram of an exemplary system configuration of an image processing apparatus of the present invention. In FIG. 1, “1” denotes an image processing apparatus such as a digital multi-function peripheral, “10” denotes a PCI (Peripheral Component Interconnect) bus, “11” denotes a CPU (Central Processing Unit), “12” denotes a system controller, “13” denotes a system memory such as a RAM (Random Access Memory), “14” denotes an I/O (input and output) controller, “14a” denotes an HDD (Hard Disk Drive) controller, “15a” and “15b” denote HDDs, “16” denotes an external interface, “17” denotes a page memory, “18” denotes an image controller, “19” denotes an image processing LSI (Large Scale Integrated circuit), “20” denotes an image forming portion, and “21” denotes an image reading portion.

The image processing apparatus 1 includes the CPU 11 that executes information processing by calculation. The CPU 11 is connected with the system controller 12 that executes inputting/outputting of data into/from the CPU 11. The system controller 12 is connected with the RAM 13 that stores temporarily data associated with processing executed by the CPU 11, and the PCI bus 10. The PCI bus 10 is connected with the I/O controller 14 that executes inputting/outputting of data into/from the PCI bus 10, and the image controller 18.

The image controller 18 is connected with the image reading portion 21 that reads an image recorded on an original document, the page memory 17 that stores image data for each page, an image processing portion (the image processing LSI 19) that processes the image data, and the image forming portion 20 that forms an image from the image data and outputs the image. The I/O controller 14 is connected with the external interface 16 such as a USB (Universal Serial Bus) and a LAN (Local Area Network) that inputs and outputs data with apparatuses outside the information processing apparatus, and the HDDs 15a and 15b that store data (only one HDD may be connected).

The present invention relates to a detecting process of a copying-prohibiting added pattern. The detecting process is executed by, for example, the image controller 18 of FIG. 1. In this case, for example, a program that causes a processing unit such as the CPU in the image controller 18 to function as each portion described later is stored in a ROM (Read Only Memory), etc., in the image controller 18; the processing unit reads out the program to the RAM, etc., in the image controller, and executes the program; and, thereby, the detecting process is achieved. The present invention can employ the form as a program as above and the form as one of various computer-readable recording media recorded with the program. The program recorded in the recording medium is read by a PC, etc., is transferred to the image processing apparatus through a network, and is incorporated executably into a ROM (in this case, a rewriteable ROM) as firmware. However, the image processing apparatus according to the present invention is not limited to an image processing apparatus that is configured to execute detection of copying-prohibiting added patterns in the image controller 18.

The invention relates to an image processing apparatus that, when M+N or more specific patterns (copying-prohibiting added patterns) for identifying a copying-prohibited original document are added to the original document, identifies the copying-prohibited original document by detecting N of those specific patterns in actual detection, and the pattern detecting method. The pattern detecting method according to the present invention includes steps to execute the detecting process in the image processing apparatus according to the present invention and the description thereof will be omitted.

In the following description, the description will be given assuming that a copying-prohibiting added pattern includes a plurality of primitive patterns each of which is formed by a dot shape consisting of black or yellow consecutive several pixels and a yellow primitive pattern is printed in a size larger than that of a black primitive pattern to make the copying-prohibiting added pattern inconspicuous and detectable. However, the color configuration and the shape of the primitive patterns are not limited to the above. The black primitive patterns and the yellow primitive patterns are assumed to have the same positional relations.

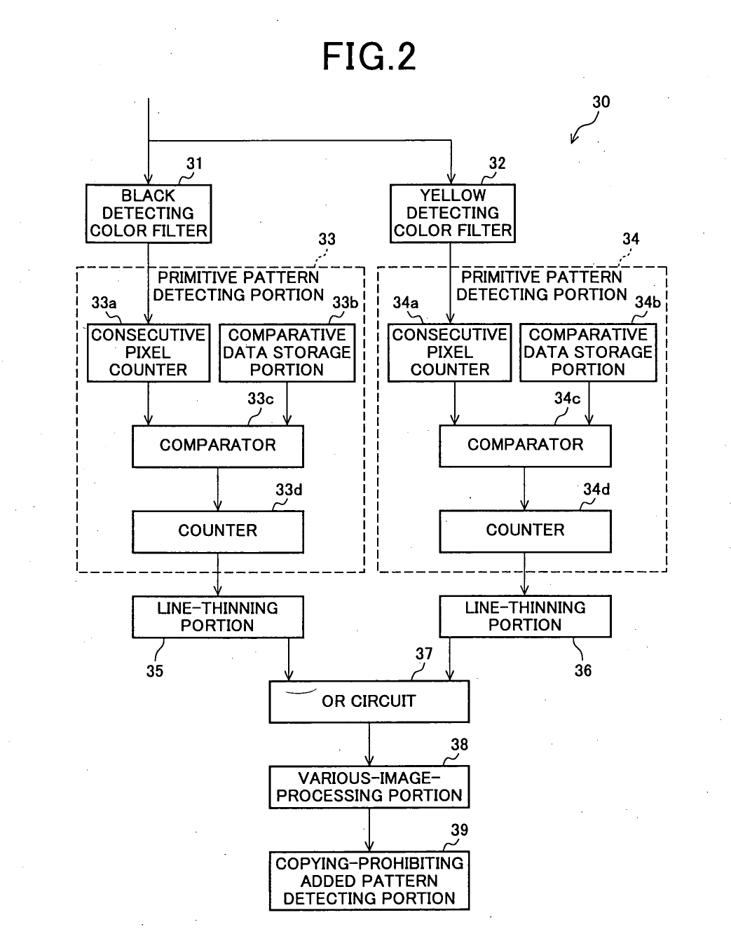

FIG. 2 is a block diagram of an exemplary configuration of an image processing apparatus according to an embodiment of the present invention. In FIG. 2, “30” denotes an image processing apparatus, “31” denotes a black detecting color filter, “32” denotes a yellow detecting color filter, “33” denotes a black primitive pattern detecting portion, “34” denotes a yellow primitive pattern detecting portion, “35” denotes a black line-thinning portion, “36” denotes a yellow line-thinning portion, “37” denotes an OR circuit (an OR processing portion), “38” denotes a various-image-processing portion, and “39” denotes a copying-prohibiting added pattern detecting portion.

The image processing apparatus 30 is an apparatus having a function of judging whether any copying-prohibiting added pattern is present in an image, and comprises the black detecting color filter (black color detecting color filter) 31, the yellow detecting color filter (yellow color detecting color filter) 32, the primitive pattern detecting portions 33 and 34, the line-thinning portions 35 and 36, the OR circuit 37, the various-image-processing portion 38, and the copying-prohibiting added pattern detecting portion 39.

The black detecting color filter 31 executes a binarizing process of the inputted image data in terms of black. The yellow color detecting color filter 32 similarly executes a binarizing process of the inputted image data in terms of yellow. The copying-prohibiting added pattern added to a copying-prohibited original document is a black pattern or a yellow pattern and, therefore, due to the binarizing process by the black detecting color filter 31 or the yellow detecting color filter 32, the primitive pattern is outputted as the binary data. As exemplified by the color filters 31 and 32 for detection, the image processing apparatus according to the present invention includes a binarizing portion that separates a plurality of single colors from the inputted image data and binarizes the single colors.

Each of the primitive pattern detecting portions 33 and 34 has a portion that detects a primitive pattern for each color from the image data of each color that is binarized by the binarizing portion. As described later, the image processing apparatus according to the present invention includes a specific pattern detecting portion that detects a copying-prohibiting added pattern based on an arrangement of the primitive patterns detected by the primitive pattern detecting portions 33 and 34. The specific pattern detecting portion will be exemplified assuming that the specific pattern detecting portion is included in the copying-prohibiting added pattern detecting portion 39. As above, detection of the primitive pattern that differs by color can be made accurate by executing the detection of the primitive pattern for each color.

The primitive pattern detecting portions 33 and 34 exemplified herein respectively include consecutive pixel counting portions 33a and 34a, comparative data storage portions 33b and 34b, comparators 33c and 34c, and counting portions (counters) 33d and 34d.

The consecutive pixel counter 33a counts the number of pixels of consecutive pixels of the binary data from the black detecting color filter 31. As the counting method thereof, the number of consecutive pixels may be counted in one dimensional direction, or the number of consecutive pixels may be counted in one dimensional direction and consecutive pixels outside the set region may be counted expanding the direction thereof to directions in two dimensions.

The comparator 33c compares the result of the counting by the consecutive pixel counter 33a with a value preset in the comparative data storage portion 33b and deletes, for example, data having the length thereof equal to or smaller than a preset number of pixels and data having the length thereof equal to or larger than a preset number of pixels. For example, when the size of a primitive pattern is five pixels by five pixels and the comparative data storage portion 33b is set for deleting data that is two-pixel long or shorter and eight-pixel long or longer, data having the length thereof equal to or smaller than two pixels and data having the length thereof equal to or larger than eight pixels are deleted.

As above, it is preferable that the primitive pattern detecting portion 33 (34) has the consecutive pixel counter 33a (34a) that counts the number of consecutive pixels and can judge and delete unnecessary data based on the count value. Thereby, unnecessary data can be deleted and the detection of the primitive patterns can be made accurate.

The counter 33d counts the number of pieces of data having the size of a primitive pattern, for example, data having the size of five pixels by five pixels from pieces of data processed by the comparator 33c and, when the counted number is a value equal to or smaller than a preset value that is, for example, a value of [(the number of data pieces judged to have a copying-prohibiting added pattern: N)×(the number of primitive patterns constituting a copying-prohibiting added pattern)×Constant], all pieces of data are deleted. By the above processes, the color data and the inputted image data of the original document added with the copying-prohibiting added pattern are removed and detection of the primitive patterns is executed.

As above, it is preferable that the primitive pattern detecting portion 33 (34) has a portion that executes a predetermined process when the number of primitive patterns detected for black (yellow) is smaller than a threshold value determined from the number of copying-prohibiting added patterns to be extracted (to be judged to have been detected) by the copying-prohibiting added pattern detecting portion 39. Thereby, unnecessary data other than the primitive patterns constituting the copying-prohibiting added pattern can be deleted and the detection of the primitive patterns can be made accurate.

The line-thinning portion 35 line-thins the data from the primitive pattern detecting portion 33 in a known method, for example, line-thins to one pixel. By matching with the size of the primitive patterns constituting a yellow copying-prohibiting added pattern described later due to this process, sharing of the processes that follow is facilitated.

As above, it is preferable that the image processing apparatus is provided with a representative point detecting portion that obtains a representative point in the primitive pattern from the primitive patterns detected for black (yellow) by the primitive pattern detecting portion 33 (34). A “representative point” refers to, for example, one pixel or several pixels at the center of a primitive pattern, etc. The line-thinning portion 35 (36) has a line-thinning portion that obtains a representative point in a primitive pattern by line-thinning as an example of the representative point detecting portion. Thereby, it is easy to detect a copying-prohibiting added pattern from primitive patterns that differ by color. Especially, by executing the line-thinning, representative points of primitive patterns respectively having different shapes can be easily extracted.

Though the description has partially been given, the yellow copying-prohibiting added pattern is processed in the same method as that used in the processing of the black copying-prohibiting added pattern. That is, the inputted image data is outputted as binary data by the yellow detecting color filter.

The data from the yellow detecting color filter 32 is counted by the consecutive pixel counter 34a in terms of the number of pixels of consecutive pixels. As the counting method thereof, the number of consecutive pixels may be counted in one dimensional direction, or the number of consecutive pixels may be counted in one dimensional direction and consecutive pixels outside the set region may be counted expanding the direction thereof to directions in two dimensions.

The comparator 34c compares the result of the counting by the consecutive pixel counter 34a with a value preset in the comparative data storage portion 34b and deletes, for example, data having the length thereof equal to or smaller than a preset number of pixels and data having the length thereof equal to or larger than a preset number of pixels. For example, when the size of a primitive pattern is eight pixels by eight pixels and the comparative data storage portion 34b is set for deleting data that is five-pixel long or shorter and 11-pixel long or longer, data having the length thereof equal to or smaller than three pixels and data having the length thereof equal to or larger than nine pixels are deleted.

The counter 34d counts the number of pieces of data having the size of a primitive pattern, for example, data having the size of eight pixels by eight pixels from pieces of data processed by the comparator 34c and, when the counted number is a value equal to or smaller than a preset value that is, for example, a value of [(the number of data pieces judged to have a copying-prohibiting added pattern: N)×(the number of primitive patterns constituting a copying-prohibiting added pattern)×Constant], all pieces of data are deleted. By the above processes, the color data and the inputted image data of the original document added with the copying-prohibiting added pattern are removed and detection of the primitive patterns is executed.

The line-thinning portion 36 line-thins the data from the primitive pattern detecting portion 34 in a known method, for example, line-thins to one pixel. Matching with the size of the primitive patterns constituting the above black copying-prohibiting added pattern is completed due to this process.

The primitive pattern detecting portion and the line-thinning portion are provided for two parts for black and yellow. This is because the size of the black primitive pattern and the size of the yellow primitive pattern are different from each other and the detection executed by the copying-prohibiting added pattern detecting portion after the addition is made accurate by executing different processes respectively to the primitive patterns. Not limiting to those supporting two colors as exemplified, to support three or more colors, color filters, primitive pattern detecting portions, and line-thinning portions respectively for those colors may surely be provided.

The data from the line-thinning portion 35 and the data from the line-thinning portion 36 are combined (added together) by the OR circuit 37 that is an example of an adding portion. The resultant data is applied with various image processes by the various-image-processing portion 38 and, thereafter, the copying-prohibiting added pattern detecting portion 39 judges presence or absence of any copying-prohibiting added pattern in the resultant data based on, for example, positional relations between the primitive patterns. By providing the above adding portion, the apparatus can cope with the case where copying-prohibiting added patterns of a plurality of colors are added.

Though the addition is executed by the OR circuit 37 in the above, the processes by the various-image-processing portion 38 and the copying-prohibiting added pattern detecting portion 39 may be executed after data for which the primitive patterns are judged to be present therein is selected by the selecting portion such as a selector. This is especially effective when a copying-prohibiting added pattern consists of single-color primitive patterns. By providing a selecting portion as above, the circuit scale of the hardware that detects copying-prohibiting added patterns can be reduced.

As exemplified with the OR circuit 37 and the selector, it is preferable that the image processing apparatus is provided with an integrating portion (unifying portion) that integrates into one the primitive patterns detected by the primitive pattern detecting portions 33 and 34 respectively for the colors. In this case, the copying-prohibiting added pattern detecting portion 39 detects a copying-prohibiting added pattern based on the arrangement of the primitive patterns integrated by the integrating portion and, therefore, the circuit scale of the hardware that detects copying-prohibiting added patterns can be reduced.

By completing the matching of the size of the primitives of the black copying-prohibiting added pattern or the yellow copying-prohibiting added pattern added to the original document by the line-thinning portion 35 or the line-thinning portion 36, the image processing apparatus is enabled to make the copying-prohibiting added pattern detecting portion 39 common to the colors. As above, it is preferable that each color detecting color filter is applied and, thereafter, primitive patterns are detected for each color and the components concerning the processes after detection are common to colors.

When the copying-prohibiting added pattern detecting portion 39 detects more copying-prohibiting added patterns than a predetermined number (N) thereof, a proper measure is taken against the image forming portion 20 shown in FIG. 1 such as prohibition of copying. As above, the image processing apparatus 30 is provided with an outputting prohibiting portion (input invalidating portion) that prohibits outputting of an inputted image when more copying-prohibiting added patterns than a predetermined number thereof are detected. The outputting prohibiting portion controls other blocks (for example, the image forming portion 20 and the external interface 16) based on the detection result.

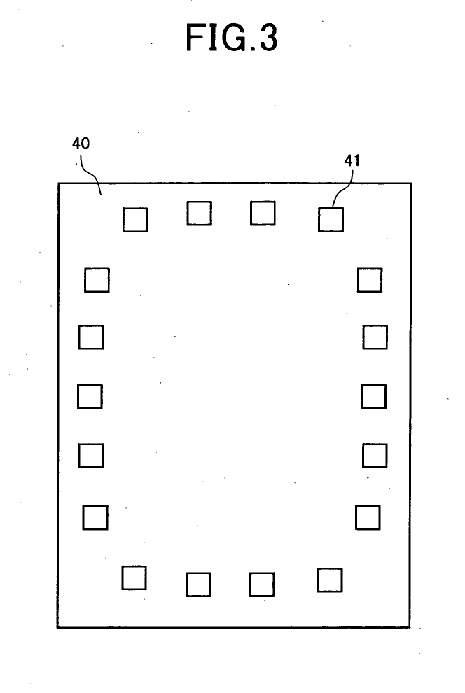

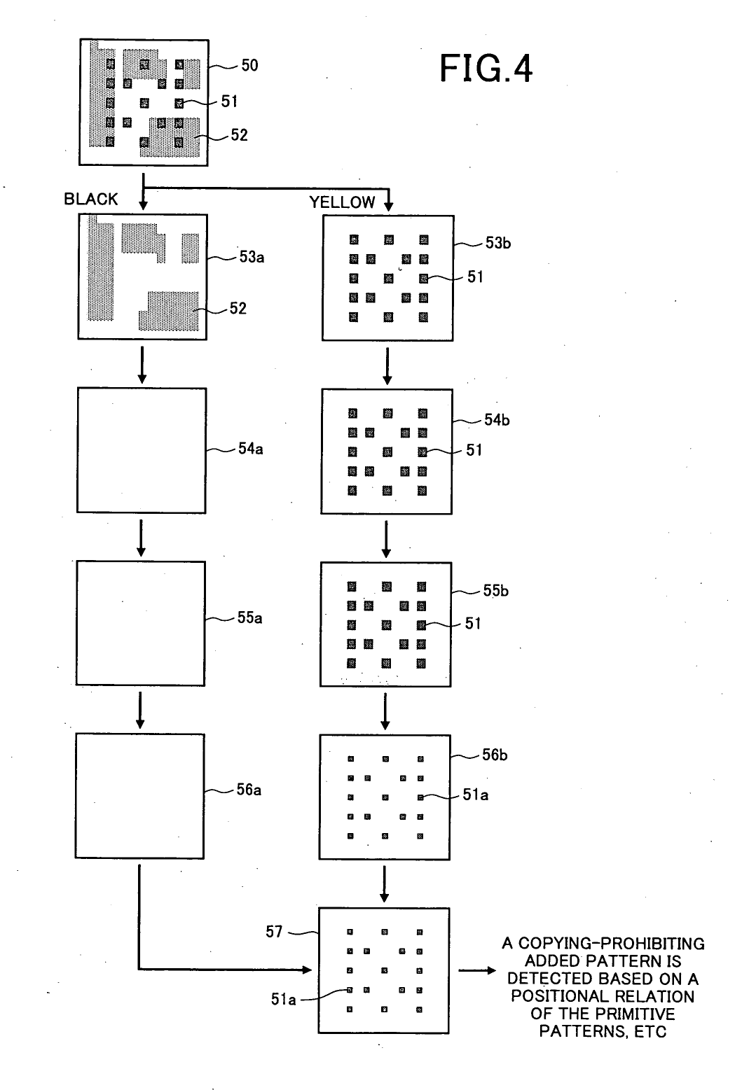

FIG. 3 shows an exemplary arrangement of a plurality of copying-prohibiting added patterns arranged in an original document. In FIG. 3, “40” denotes an original document and “41” denotes a copying-prohibiting added pattern. M+N or more copying-prohibiting added patterns are arranged on the original document 40. A detecting process of one copying-prohibiting added pattern 41 in the M+N patterns will be described below as to exemplary shapes in the processing to the adding process by the OR circuit 37 described above referring to FIGS. 4 to 7. That is, processes described below are executed to the plurality of copying-prohibiting added pattern 41 as parallel or sequential processing.

FIG. 4 is an explanatory view of processes to an exemplary original document with a yellow copying-prohibiting added pattern arranged in a black image. In FIG. 4, “50” denotes image data, “51” denotes a primitive pattern, and “52” denotes an inputted image (black). The inputted image is the image captured by the image reading portion 21, etc., of FIG. 1 and refers to characters, photographs, etc., to be copied.

For the image data 50, the inputted images (black) 52 are outputted by the black detecting color filter 31 as color filter-passed image data 53a and the primitive patterns 51 are outputted by the yellow detecting color filter 32 as color filter-passed image data 53b. Though the inputted images (black) 52 are deleted by the comparator 33c in comparison-completed image data 54a, the primitive patterns 51 remain even in comparison-completed image data 54b outputted from the comparator 34c.

Data that has substantially the size of a primitive pattern and is not a primitive pattern constituting a copying-prohibiting added pattern is deleted by the counter 34d. However, the primitive patterns 51 constituting a copying-prohibiting added pattern remain even in counting-completed image data 55b. Counting-completed image data 55a is image data after the counting has been executed thereto by the counter 33d.

By the line-thinning portion 36, a line-thinning process of the primitive patterns 51 is executed and line-thinning-completed image data 56b is outputted. Thereafter, black detected data (the line-thinning-completed image data 56a) and yellow detected data (the line-thinning-completed image data 56b) applied with the line-thinning processes are added to each other by the OR circuit 37 and OR process-completed image data 57 having thin-lined primitive patterns 51a is outputted.

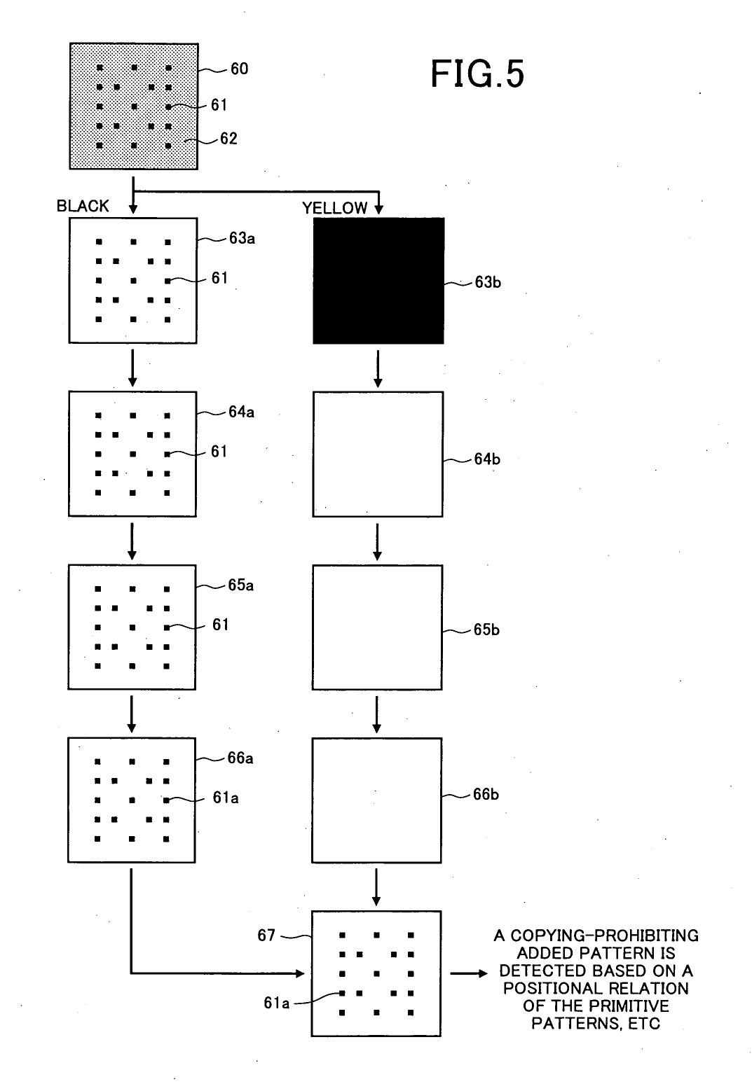

FIG. 5 is an explanatory view of processes to an exemplary original document with a black copying-prohibiting added pattern arranged in a yellow image. In FIG. 5, “60” denotes image data, “61” denotes a primitive pattern, and “62” denotes an inputted image (yellow).

For the image data 60, the primitive patterns 61 are outputted by the black detecting color filter 31 as color filter-passed image data 63a and the inputted image 62 is outputted by the yellow detecting color filter 32 as color filter-passed image data 63b. Though the primitive patterns are outputted by the comparator 33c in comparison-completed image data 64a, the inputted image 62 is deleted in comparison-completed image data 64a.

Data that has substantially the size of a primitive pattern and is not a primitive pattern constituting a copying-prohibiting added pattern is deleted by the counter 33d. However, the primitive patterns 61 constituting a copying-prohibiting added pattern remain even in counting-completed image data 65a. Counting-completed image data 65b is image data after the counting has been executed thereto by the counter 34d.

By the line-thinning portion 35, a line-thinning process of the primitive patterns 61 is executed and line-thinning-completed image data 66a is outputted. Thereafter, black detected data (the line-thinning-completed image data 66a) and yellow detected data (the line-thinning-completed image data 66b) applied with the line-thinning processes are added to each other by the OR circuit 37 and OR process-completed image data 67 having thin-lined primitive patterns 61a is outputted.

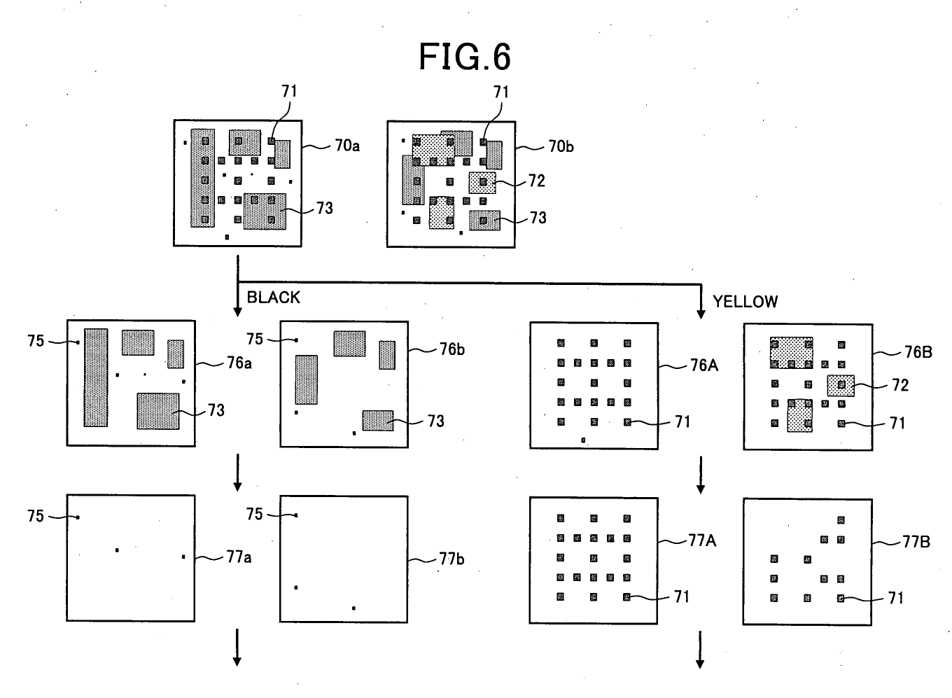

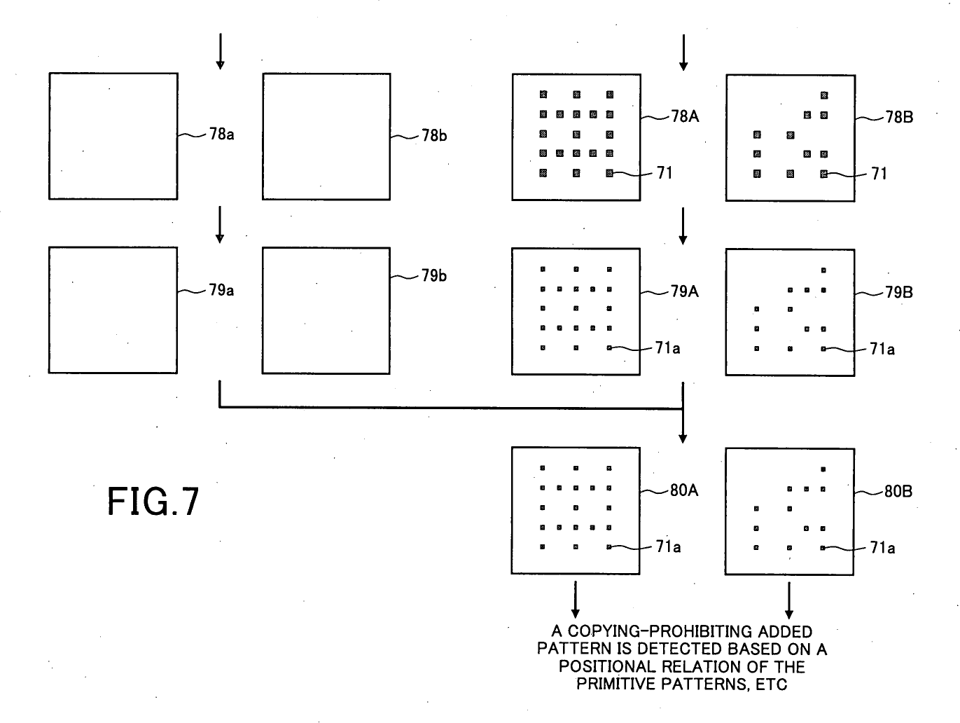

FIGS. 6 and 7 are explanatory views of processes to an exemplary original document with a yellow copying-prohibiting added pattern arranged in a black-and-yellow image. In FIGS. 6 and 7, “70a” and “70b” denote respectively pieces of image data, “71” denotes a primitive pattern, “72” denotes an inputted image (yellow), “73” denotes an inputted image (black), and “75” denotes an inputted image (black) having the size that is substantially the size of a primitive pattern. The part denoted by “75” will be referred to as “inputted image (black and small)”.

For the image data 70a and 70b, the inputted images (black) 73 and the inputted images (black and small) 75 are outputted by the black detecting color filter 31 as color filter-passed image data 76a and 76b, and the primitive patterns 71 and the inputted images (yellow) 72 are outputted by the yellow detecting color filter 32 as color filter-passed image data 76A and 76B.

Though the inputted images (black) 73 are deleted by the comparator 33c in comparison-completed image data 77a and 77b, the inputted image (black and small) 75 remains. Though the primitive patterns 71 overlapping the inputted image (yellow) 72 and the inputted images (yellow) 72 are deleted by the comparator 34c in comparison-completed image data 77B, the primitive patterns not overlapping the inputted image (yellow) 72 are outputted in the comparison-completed image data 77A and 77B.

Data (in this case, the inputted image (black and small) 75) that has substantially the size of a primitive pattern and is not a primitive pattern constituting a copying-prohibiting added pattern is deleted by the counter 33d and counting-completed image data 78a and 78b are outputted. The primitive patterns 71 constituting a copying-prohibiting added pattern remain even in counting-completed image data 78A and 78B.

By the line-thinning portions 35 and 36, line-thinning processes of the primitive patterns 71 are executed and line-thinning-completed image data 79A and 79B are outputted. Thereafter, black detected data (the line-thinning-completed image data 79a and 79b) and yellow detected data (the line-thinning-completed image data 79A and 79B) applied with the line-thinning processes are added to each other by the OR circuit 37 and OR process-completed image data 80A and 80B each having thin-lined primitive patterns 71a are outputted.

At this time, though a portion of the primitive patterns 71a in the OR-process-completed image data 80B is lacking, primitive patterns having no lacking, that is, a complete copying-prohibiting added pattern (the OR-process-completed image data 80A) is present and only N copying-prohibiting added patterns need to be identified of the M+N copying-prohibiting added patterns arranged in the original document. Therefore, the judgment is possible.

As shown with the OR-process-completed image data 57, 67, 80A, and 80B shown in FIGS. 4, 5, and 7, matching of size between the black primitive patterns and the yellow primitive patterns is completed and, therefore, the copying-prohibiting added pattern detecting portion that follows can be common to colors.

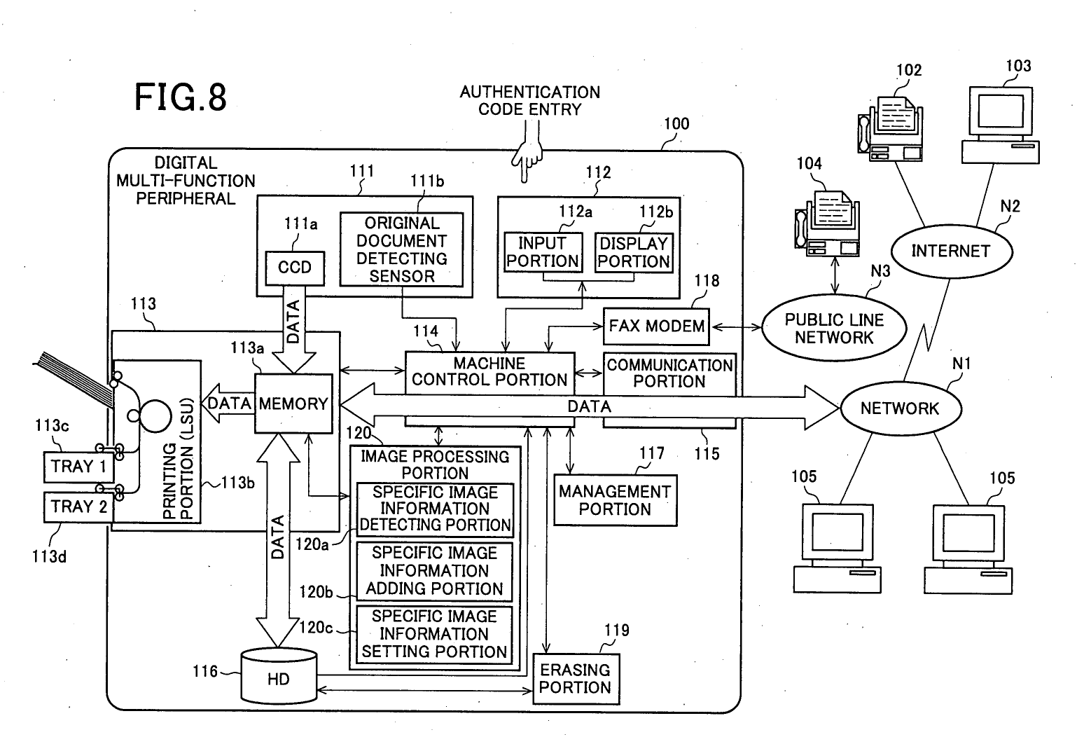

FIG. 8 is an explanatory block diagram of an exemplary configuration of a digital multi-function peripheral that is an example of the image processing apparatus of the present invention. In FIG. 8, “100” denotes a digital multi-function peripheral. The digital MFP (multi-function peripheral) 100 is exemplified by an apparatus configured as an MFP including functions of a copying machine, a printing apparatus, a facsimile apparatus, and a scanning apparatus as an example of the image processing apparatus of FIG. 1.

The digital MFP 100 comprises a machine control portion 114 including a CPU which performs arithmetic operations and a RAM and the like which store temporal information in association with the operations. A ROM which stores a control program for controlling the digital MFP 100 is included in the machine control portion 114. A management portion 117 which is a memory storing management information (various items of control information) for managing the processing conducted by the digital MFP 100 is connected to the machine control portion 114. An image reading portion 111 which reads images recorded on the recording paper to generate image data is connected to the machine control portion 114. The image reading portion 111 is provided with a CCD 111a for reading original document images as image data and an original document detecting sensor 111b which detects the presence or absence of the original document.

An image forming portion 113 which functions as an image forming portion to form image data on recording paper is connected to the machine control portion 114. The image forming portion 113 is provided with a memory 113a for temporarily storing the image data, a printing portion (LSU) 113b which forms images from the image data stored by the memory 113a for recording them on recording paper, and sheet trays 113c, 113d from which recording paper is fed for the image formation at the printing portion 113b. The digital MFP 100 can form images at the printing portion 113b after the image data generated by the image reading portion 111 are stored on the memory 113a once. In such a manner, the digital MFP 100 functions as a copy machine.

A FAX modem 118 for conducting facsimile communication is connected to the machine control portion 114 exemplified in FIG. 8. The FAX modem 118 is also connected to a public line network (telephone line network) N3. The digital MFP 100 is capable of transmitting the image data which is generated by the image reading portion 111 to another facsimile apparatus 104 via the public line network N3 which is connected to the FAX modem 118 by the facsimile communication. The digital MFP 100 is also capable of receiving the image data transmitted from the other facsimile apparatus 104 via the public line network N3 at the FAX modem 118 to form images from the received image data at the image forming portion 113. In such a manner, the digital MFP 100 also functions as a facsimile apparatus.

A communication portion (transceiver portion) 115 which enables the digital MFP 100 to transmit/receive information to/from an external source is connected to the machine control portion 114. The communication portion 115 can be connected to a communication network N1 such as intra-LAN and the like. One or more personal computer(s) (PC(s)) 105 can be connected to the communication network N1. In a usual situation at which the digital MFP 100 is operated alone, the communication portion 115 is connected to the communication network N1 for exchanging information with PC(s) 105 via the communication network N1.

The digital MFP 100 is capable of transmitting image data which is generated by the image reading portion 111 to PC 105 from the communication portion 115. Thus, the digital MFP 100 functions as a scanner apparatus. Further, the digital MFP 100 is capable of receiving the image data transmitted from PC 105 at the communication portion 115 for forming images from the received image data at the image forming portion 113. Thus, the digital MFP 100 serves as a printer apparatus.

The communication network N1 is connected to a wide area communication network N2 such as the Internet. The communication portion 115 is capable of receiving image data from the Internet facsimile apparatus 102 or an external PC 103 which is connected to the wide area communication network N2 via the communication network N1 and wide area communication network N2 through techniques such as transmitting image data with attaching them to an electronic mail. Thus, the digital MFP 100 also serves as an Internet facsimile apparatus.

An operation portion 112 which accepts operations by the user is connected to the machine control portion 114. The operation portion 112 comprises an input portion 112a such as a touch panel or ten-key pad from which information such as a control instruction is entered by the operation of the user, and a display portion 112b such as a liquid crystal panel which displays information necessary for the operation. Authentication codes which authenticate the administrator or user (i.e., operator) of the present digital MFP 100 are entered into the operation portion 112. In some cases, the authentication codes may be entered from an external device via the FAX modem 118 or communication portion 115.

A hard drive (HD) 116 is connected to the machine control portion 114. The HD 116 stores image data which is related with image processing of the image data which is generated by the image reading portion 111, and the like. An erasing portion 119 is also connected to the machine control portion 114. The erasing portion 119 erases data recorded and retained on the HD 116 under control of the machine control portion 114.

The machine control portion 114 is connected with an image processing portion 120 that realizes a process of adding specific image information and a process of detecting specific image information relating to the present invention. It is necessary for the image processing portion 120 to include a specific image information detecting portion 120a (described later) relating to the detection of the specific image information conducted with the configuration as described in FIG. 2. It is preferable that the image processing portion 120 includes an after-mentioned specific image information adding portion 120b and specific image information setting portion 120c relating to the adding process of the specific image information, but the portions 120b, 120c are not indispensable components respectively.

The specific image information adding portion 120b adds specific image information representing a specific image to image data. In the case of an image recording process, the specific image information is information representing a recorded matter recording a specific image.

The specific image information adding portion 120b preliminarily retains the specific image information to be added to image data (or allows another accessible memory to retain the information), adds the specific information to the image data under the control of the machine control portion 114 for adding the specific image information, and allows the memory 113a to retain the image data. The image data processed by the image processing portion 120 are print data in the form of final output from the printing portion 113b. As described above, the specific image information is used to prohibit copying (or to discourage a user by allowing the user to recognize that copying is prohibited) and, for example, in the case of a color MFP, yellow specific image information is added in an invisible manner. In the case of a black-and-white MFP (or black-and-white output of a color MFP), black (gray) with controlled density is added in an invisible manner.

The specific image information setting portion 120c sets a color and/or the number of the specific image information. The specific image information setting portion 120c sets a color and the number of the specific image information in accordance with the setting control of the machine control portion 114 in advance, and the specific image information adding portion 120b adds the specific image information to the image data based on the color and number set by the specific image information setting portion 120c for the preliminarily retained specific image information to be added to the image data. The MFP in this example includes a portion that performs an image process (such as image reproduction) for the specific image information to form an image with the set color or number. Since the specific image information setting portion 120c sets the color and number (and position) of the specific image information, the detection accuracy of the specific image information can be increased regardless of a usage pattern of a user when the specific image information is detected.

Preferably, the specific image information setting portion 120c includes an additional property selecting portion that allows a user to select a color and/or number of the specific image information from the operation portion 112, etc. Preferably, the specific image information setting portion 120c includes a position selecting portion that allows a user to select a position to which the specific image information is added. With the position selecting portion, a user can select from the operation portion 112, etc., whether the specific image information is located all over paper or located at a corner only, for example. Preferably, a user capable of performing the user setting is an administrating user. The specific image information setting portion 120c may automatically vary and set the size of the specific image information depending on the setting of the color and/or number of the specific image information.

When the printing portion 113b forms an image from image data read by the image reading portion 111 or image data input externally via the FAX modem 118 or the communication portion 115, the image forming apparatus of the embodiment with the above configuration adds the specific image information.

A plurality of image data input portions may be included to input image data subjected to the image processing in this way, and the specific image information setting portion 120c may set a color and/or the number of the specific image information in advance for each of the plurality of the image data input portions (corresponding to image input modes) The plurality of the image data input portions indicate not only differences in the input path of the image data, but also each of the image input modes such as printing in a photograph mode, printing in a black-and-white mode, printing in a mode for printing darker, or printing in a mode for printing lighter, even when the image data are read from the same original document, for example.

In the setting and adding processes of the specific image information, the preferred implementations described above may be employed appropriately to perform the processes. For example, the specific image information (specific pattern) can be selected from single toner colors of YMCK, and a plurality of patterns with the same color or different colors may be added to one piece of output paper. When printing in a black-and-white copying (FAX, printer) mode, a color of the added pattern may be black, and when printing in a color mode, the color may be selected from four colors of YMCK. When a yellow pattern is selected, the pattern may be colored deeper or include larger dots as compared to the case of selecting a black pattern such that the pattern is detected even when recycled paper is used. When the image data are printed as a monochromatic binary format image, a density value of the additional pattern may be lower than a density value for printing the image data.

The specific pattern images may be added as at least M+N same images. When the patterns are actually detected, since an original document is recognized as an original document with additional information by detecting N patterns, only a part of the added patterns is needed to be detected and, therefore, the additional pattern can be an inconspicuous pattern. By reducing a primitive size of the additional printing pattern printed in black as compared to that of the pattern printed in yellow, the pattern can be detected when the pattern is printed on recycled paper and the pattern can be an inconspicuous, light and small pattern.

The additional pattern images may be added to at least four corners of fed paper, which is useful at the time of one-set-two-copy, or may be added to at least four corners of an original document paper, which is useful at the time of two-in-one. However, by adding the additional pattern images all over the fed paper, the images can be detected even when the paper is cut and pasted. The number of the additional pattern images may be varied depending on security strength.

On the other hand, the image processing portion 120 includes a specific image information detecting portion 120a of the present invention that detects whether the specific image information is included in the image data read by the image reading portion 111 and stored in the memory 113a. The specific image information detecting portion 120a corresponds to each portion for detecting specific patterns exemplified in FIG. 2. If the image data include the specific image information as a result of the detection by the specific image information detecting portion 120a, the machine control portion 114 performs control to prohibit copying of the image data (to disable the image formation in the image forming portion 113).

Preferably, the present invention includes an outputting prohibiting portion (image disabling portion) in the image processing portion 120, etc. In other words, the outputting prohibiting portion is a portion that prohibits outputting of an inputted image when more copying-prohibiting added patterns than a predetermined number thereof are detected. By this portion, the image information read by the image reading portion 111 can be disabled if the specific image information detecting portion 120a determines that the specific image information exists. Since some original documents have congested characters or an output (print and FAX output) part called trash, the specific image information setting portion 120c preferably sets and forms the predetermined image to be added such that at least M+N same patterns are added as described above and, at the time of recognition, the specific image information detecting portion 120a detects the image when N additional patterns are recognized. Information of N may be determined by percentage of the number of the additional patterns of course.

As above, according to the present invention, the judgment of a specific pattern can be made accurate and easy and a copying-prohibited original document can be judged regardless of the color of the original document and inputted image information of the copying-prohibited original document added with the specific pattern and even when the size of the specific pattern differs.

1. An image processing apparatus comprising:
a binarizing portion that separates a plurality of single colors from image data inputted and binarizes the single colors;
a primitive pattern detecting portion that detects a primitive pattern for each color from the image data of the single colors that is binarized by the binarizing portion; and
a specific pattern detecting portion that detects a specific pattern based on an arrangement of the primitive pattern detected by the primitive pattern detecting portion.

2. The image processing apparatus of claim 1, comprising:
an integrating portion that integrates into one the primitive patterns detected by the primitive pattern detecting portion respectively for the single colors, wherein
the specific pattern detecting portion detects the specific pattern based on an arrangement of the primitive pattern integrated by the integrating portion.

3. The image processing apparatus of claim 2, wherein
the integrating portion is an adding portion that integrates into one the primitive patterns detected by the primitive pattern detecting portion respectively for the single colors by adding these patterns to each other.

4. The image processing apparatus of claim 2, wherein
the integrating portion is a selecting portion that selects data from which the primitive pattern is detected of the primitive patterns detected by the primitive pattern detecting portion respectively for the single colors.

5. The image processing apparatus of claim 1, comprising:
a representative point detecting portion that obtains a representative point in the primitive pattern from the primitive patterns detected by the primitive pattern detecting portion respectively for the single colors.

6. The image processing apparatus of claim 5, wherein
the representative point detecting portion has a line-thinning portion that obtains the representative point in the primitive pattern by line-thinning.

7. The image processing apparatus of claim 1, wherein
the primitive pattern detecting portion executes a predetermined process when the number of primitive patterns detected for each color is smaller than a threshold value determined from the number of the specific patterns to be extracted by the specific pattern detecting portion.

8. The image processing apparatus of claim 1, wherein
the primitive pattern detecting portion has a consecutive pixel counter that counts the number of consecutive pixels, and determines unnecessary data based on a count value of the consecutive pixel counter.

9. The image processing apparatus of claim 1, wherein
the specific pattern is a pattern that indicates prohibition of copying, and wherein
the image processing apparatus comprises an outputting prohibiting portion that prohibits outputting of an inputted image when more specific patterns than a predetermined number thereof are detected by the specific pattern detecting portion.

10. A pattern detecting method comprising:
a binarizing step of separating a plurality of single colors from image data inputted and binarizing the single colors;
a primitive pattern detecting step of detecting a primitive pattern for each color from the image data of the single colors that is binarized at the binarizing step; and
a specific pattern detecting step of detecting a specific pattern based on an arrangement of the primitive pattern detected at the primitive pattern detecting step.

11. The pattern detecting method of claim 10, further comprising:
an integrating step of integrating into one the primitive patterns detected at the primitive pattern detecting step respectively for the single colors, wherein
at the specific pattern detecting step, the specific pattern is detected based on an arrangement of the primitive pattern integrated at the integrating step.

12. A program that is incorporated into the image processing apparatus of claim 1 and causes a processing unit in the image processing apparatus to function as each portion.

13. A computer-readable recording medium that is recorded with the program of claim 12.
